(19) United States
(12) Patent Application Publication
(10) Pub. No.: US 2012/0043103 A1
(43) Pub. Date: Feb. 23, 2012

(54) Splice Enclosure

(76) Inventor: Hongjun Yin, Shanghai (CN)

(21) Appl. No.: 13/212,677

(22) Filed: Aug. 18, 2011

(30) Foreign Application Priority Data
Aug. 18, 2010 (CN) 201020299236.7

(51) Int. Cl. H02G 3/08

(52) U.S. Cl. 174/50

(57) ABSTRACT

A splice enclosure having a first casing, a second casing and a cable splice receiving chamber for receiving a cable splice or joint. The first casing includes a first engagement portion, while the second casing includes a second engagement portion. The cable splice receiving chamber is formed by the first and second engagement portions connect when the first and second casings are closed together. At least one of the first and second engagement portions includes an elongated groove having a broadened portion for escaping gas.

### CROSS-REFERENCE TO RELATED APPLICATION

This application claims the benefit under 35 U.S.C. §119(a)-(d) of Chinese Patent Application No. 201020299236.7, filed on Aug. 18, 2010.

### FIELD OF INVENTION

The present invention relates to a splice enclosure, particularly to a splice enclosure having a sealant injection groove.

### BACKGROUND

A cable splice or joint is usually used to splice cables, feeders, optical fibers or the like, and the splicing location that need waterproof sealing so that normal performance of the spliced cables, feeders, optical fibers or the like is ensured. A splice enclosure is developed to seal the cable splice after the splicing in order to produce a dust-proof and moisture-proof effect.

A known splice enclosure includes a first casing and a second casing which are connected together in a turnable manner. When the first and second casings are closed, an inner receiving space is formed therein to receive a joint of the cables or the like. Ring-shaped grooves are provided at inner peripheries of both the first and the second casings. After sealant is injected into the ring-shaped grooves, sealant forms sealing surfaces along the grooves; and with the first and second casings being closed, the sealant along the sealing surfaces are pressed and thus the joint of cables or the like inside the first and second casings is sealed.

In the prior art, the sealant is injected into the ring-shaped groove through a sealant-injection port provided at the ring-shaped groove. Because gas should be discharged from the ring-shaped groove during the sealant injection, a venting port is provided in the ring-shaped groove. A protrusion is formed by the sealant in the groove after the sealant injection is completed, and as a result, the protrusion in turn makes the sealing surfaces uneven, and this unevenness has an adverse effect on the sealing.

### SUMMARY

The invention has been made to overcome or alleviate at least one aspect of the above mentioned disadvantages.

Accordingly, an object of invention, among others, is to provide a splice enclosure in which elastic sealing material injected into elongated grooves to form even sealing surfaces along the enclosure, and thus an efficient sealing effect is obtained.

A splice enclosure having a first casing, a second casing and a cable splice receiving chamber for receiving a cable splice or joint. The first casing includes a first engagement portion, while the second casing includes a second engagement portion. The cable splice receiving chamber is formed by the first and second engagement portions connect when the first and second casings are closed together. At least one of the first and second engagement portions includes an elongated groove having a broadened portion for escaping gas.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of an splice enclosure according to an exemplary embodiment of the present invention, in which the enclosure is opened;

FIG. 2 is a plan view of FIG. 1; and

FIG. 3 is a perspective view of the splice enclosure when a cable splice is sealed by the enclosure.

### DETAILED DESCRIPTION OF THE EMBODIMENT(S)

Exemplary embodiments of the invention will be described hereinafter in detail with reference to the attached drawings, wherein the like reference numerals refer to the like elements throughout the specification. These embodiments should not be construed as being limited to the embodiment set forth herein, rather for illustrative purpose.

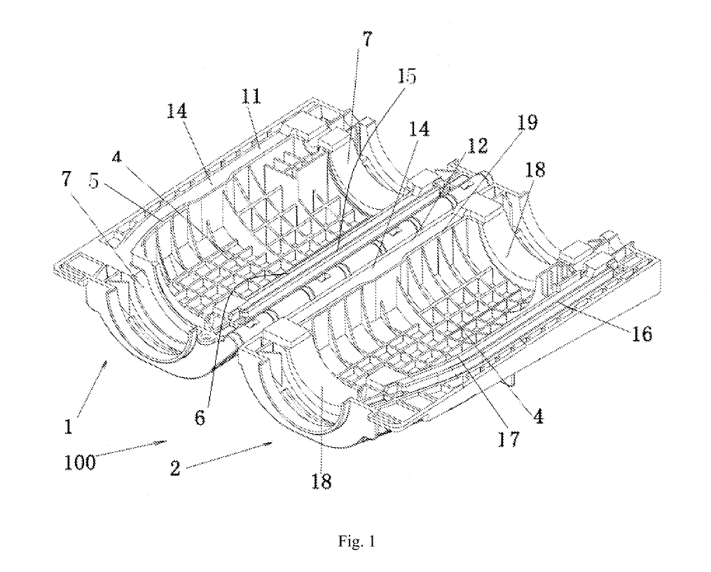

Referring to FIGS. 1-3, an enclosure 100 for sealing a cable splice according to an exemplary embodiment of the invention is shown. In the embodiment shown, the enclosure 100 includes a first casing 1 with a first ring-shaped engagement portion and a second casing 2 having a second ring-shaped engagement portion. When the second casing 2 and the first casing 1 are closed, by means of engagement between the first and second engagement portions, the second casing 2 and the first casing 1 form a cable splice receiving chamber for receiving a cable splice for joining cables, optical fibers, feeders or the like (hereinafter two cables 3 are indicated or mentioned only for illustration). At least one of the first and the second engagement portions is formed with at least one elongated groove for filling sealing material, for example, a sealant such as gel. Each elongated groove may include a first elongated groove 11, a second elongated groove 12 and a third elongated groove 13 which are connected in order (and alternatively, they may be separated from each other), the at least one elongated groove including at least one broadened portion 14 whose cross section has an enlarged width with respect to other portion of the elongated grooves. The first casing 1 and the second casing 2 may have the same shape, and main bodies thereof are substantially arc shaped in cross section. Further, each of the main bodies is formed with a substantially semicircular receiving section 4 at a substantial middle portion thereof, thus, a substantially cylindrical receiving portion is formed by the two semicircular receiving sections 4 to receive the cable splice or joints for splicing the two cables 3 when the first and second casings 1 and 2 are engaged together.

The first casing 1 may be rotatbly connected with the second casing 2 alongside portions in a longitudinal direction of the enclosure. Specifically, the first and second casings may be connected by a hinge, a pivot or a pin, or may be connected together in a foldable manner. The first elongated groove 11, the second elongated groove 12, the third elongated groove 13 may be communicated in sequence to form a ring-shaped elongated groove at the first and/or second engagement portion.

In another embodiment of the invention, the first engagement portion of the first casing 1 includes a first longitudinal engagement portion 5 and a second longitudinal engagement portion 6 which are respectively located at both sides of the receiving chamber substantially in a longitudinal direction (length direction) of the enclosure 100. The second engagement portion of the second casing 2 includes a third longitudinal engagement portion 17 and a fourth longitudinal engagement portion 19 which are respectively located along both sides of the receiving chamber in the longitudinal direction of the enclosure 100. The third longitudinal engagement portion 17 and the fourth longitudinal engagement portion 19 are in correspondence with the first longitudinal engagement portion 5 and the second longitudinal engagement portion 6, respectively, so that the third longitudinal engagement portion 17 and the fourth longitudinal engagement portion 19 are in close engagement with the first longitudinal engagement portion 5 and the second longitudinal engagement portion 6, respectively, when the first casing 1 and the second casing 2 are closed.

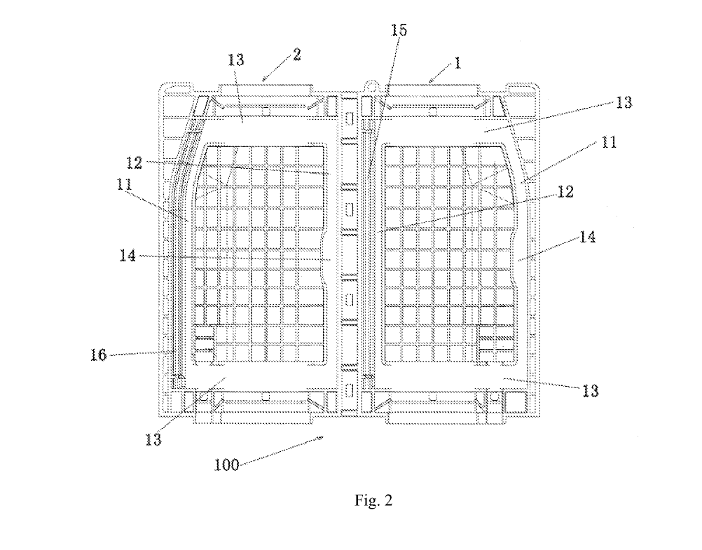

In addition, the first elongated groove 11 is provided along one or two of the first and third longitudinal engagement portions 5, 17 (that is, the two engagement portions away from the connected sides in FIGS. 1 and 2), while the second elongated groove 12 is provided along one or two of the second and fourth longitudinal engagement portions 6, 19 (that is, the two engagement portions near the connected sides in FIGS. 1 and 2).

Further, the first elongated groove 11 is provided along one (for example, the first longitudinal engagement portion 5) of the first and third longitudinal engagement portions 5 , 17, while a first protruding rib 16 corresponding to the first elongated groove 11 is provided along the other (for example, the third longitudinal engagement portion 17) of the first and third longitudinal engagement portions 5, 17. Similarly, the second elongated groove 12 is provided along one (for example, the fourth longitudinal engagement portion 19) of the second and fourth longitudinal engagement portions 6, 19, while a second protruding rib 15 corresponding to the second elongated groove 12 is provided along the other (for example, the second longitudinal engagement portion 6) of the second and the fourth longitudinal engagement portions 6, 19.

In an exemplary embodiment, the at least one broadened portion 14 is provided at a substantial central location(s) of the first elongated groove 11 and/or the second elongated groove 12.

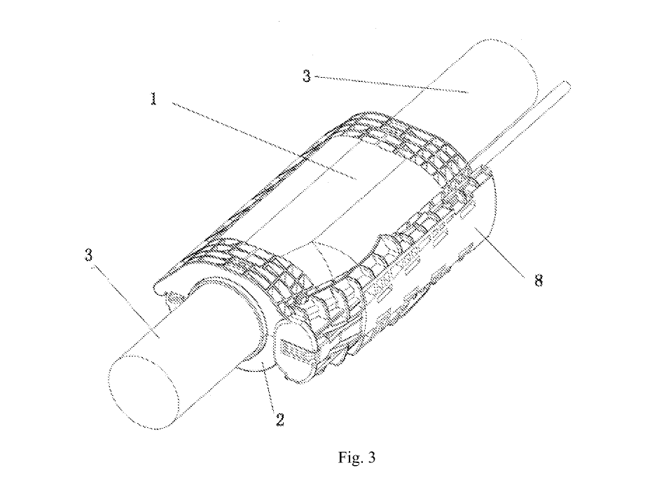

In a further exemplary embodiment, the first engagement portion further includes two first transverse engagement portions 7, which are located along both sides of the receiving chamber substantially in a transverse direction (width direction) of the enclosure 100, and the second engagement portion further includes two second transverse engagement portions 18, corresponding to the first transverse engagement portions 7, which are positioned along both sides of the receiving chamber substantially in the transverse direction of the enclosure 100. Each of the first and second transverse engagement portions 7 and 18 is positioned with the third elongated groove 13 and is formed into a generally semicircular receiving section (refer to FIG. 1), the third elongated groove 13 running along the semicircular receiving section. Thus, when the first casing 1 and the second casing 2 are closed, the first and second transverse engagement portions 7 and 18 are connected together and form substantial circular openings for receiving spliced cables 3 (refer to FIG. 3), while at the same time, the cable splice or the joint having a larger size than the diameters of the cables 3 is received in the receiving chamber defined by the first and second casings 1 and 2.

Next, an operation process of The splice enclosure according to the invention will be described. First, the first casing 1 and the second casing 2 are opened from the sides that are not hinged. The first elongated groove 11, the second elongated groove 12 and the third elongated groove 13 are then covered by a mould or die shaped to fit with the first elongated groove 11, the second elongated groove 12 and the third elongated groove 13. Next, sealant having a certain elasticity is injected into the elongated grooves through an opening of the mould. When the sealant in the elongated grooves forms a ring-shaped sealing surface, a cable splice or joint for two cables 3 is placed in one casing (for example, in the first casing 1), while the cables 3 extend through the semicircular receiving sections respectively. Then, the other casing (for example, the second casing 2) is turned or folded so that the two casings are in close engagement, in this case, the strip-shaped protruding rib 16 at the second casing 2 is in close contact with the elastic sealant in the corresponding first elongated groove 11 of the first casing 1. Additionally, the strip-shaped protruding rib 15 along the first casing 1 is in close contact with the elastic sealant in the corresponding second elongated groove 12 of the second casing 2. At the same time, the sealant in the third elongated grooves 13 is in close contact with the cables 3, such that the cable splice or joint for the cables 3 is sealed within the enclosure of the invention.

According to the enclosure of the invention, when the sealant is injected into the elongated grooves and flows in the elongated grooves, gas within the elongated grooves will be compressed and accumulates within a segment of the broadened portion 14, which is wider than other part of the elongated grooves so as to prevent bubbles from being formed along the upper sealing surfaces of the sealant, and therefore, the elastic substance formed by the sealant can form even sealing surfaces. Those skilled in the art will appreciate that a different number of broadened portions 14 may be provided if necessary, and the broadened portion 14 may be used as an injection portion for injecting the sealant. Additionally, the broadened portion 14 may be positioned at generally central locations of the first and second elongated grooves 11, 12, or be positioned different than the central locations.

Though one of the two corresponding engagement portions is provided with a elongated groove, and the other is provided with a protruding rib, the present invention is not limited to this. In an alternative embodiment, one of the first and third longitudinal engagement portions 5, 17 is provided with the first elongated groove 11, while the other of the first and third longitudinal engagement portions 5, 17 is formed into the first planar structure. One of the second and fourth longitudinal engagement portions 6, 19 is provided with the second elongated groove 12, while the other of the second and fourth longitudinal engagement portions 6, 19 is formed into the second planar structure. Hence, after the sealant is injected into the first and second elongated grooves 11, 12 and the first and second casings 1 and 2 are closed, the sealant in the elongated grooves and the planar structures may be engaged to achieve sealing.

In a still further embodiment, corresponding elongated grooves 11, 12, 13 may be provided in each one of the first, the second, the third and the fourth longitudinal engagement portions 5, 6, 17, 19, and after the sealant is injected into these elongated grooves 11, 12, 13 and the first and second casings 1, 2 are closed, the sealant in the facing elongated grooves 11, 12, 13 (in the opposite casing) may be engaged with each other to achieve sealing.

In the exemplary embodiments mentioned above, the elastic substance used as the sealant is gel, however, in an alternative embodiment, the elastic substance may be rubber.

In addition, the enclosure further includes a fastening device 8 for holding the first and second casings 1 and 2 in the closed position.

Although several exemplary embodiments have been shown and described, it would be appreciated by those skilled in the art that various changes or modifications may be made in these embodiments without departing from the principles and spirit of the disclosure, the scope of which is defined in the appended claims and their equivalents.

What is claimed is:

1. An splice enclosure, comprising:
a first casing having a first engagement portion;
a second casing having a second engagement portion;
a cable splice receiving chamber formed by the first and second engagement portions;
wherein at least one of the first engagement portion and the second engagement portion includes an elongated groove having a broadened portion.

2. The splice enclosure according to claim 1, wherein the elongated groove includes a first elongated groove, a second elongated groove and a third elongated groove which are sequentially engageable.

3. The splice enclosure according to claim 2, wherein the first engagement portion includes a first longitudinal engagement portion and a second longitudinal engagement portion positioned respectively along both sides of the cable splice receiving chamber substantially along a longitudinal direction of the splice enclosure.

4. The splice enclosure according to claim 3, wherein the second engagement portion includes a third longitudinal engagement portion and a fourth longitudinal engagement portion that respectively engage with the first longitudinal engagement portion and the second longitudinal engagement portion when the first and second casings are closed together.

5. The splice enclosure according to claim 4, wherein the first elongated groove is positioned along at least one of the first longitudinal engagement portion and the third longitudinal engagement portion.

6. The splice enclosure according to claim 5, wherein the second elongated groove is positioned along at least one of the second longitudinal engagement portion and the fourth longitudinal engagement portion.

7. The splice enclosure according to claim 5, wherein the first elongated groove is positioned along one of the first longitudinal engagement portion and the third longitudinal engagement portion.

8. The splice enclosure according to claim 7, further comprising a first protruding rib corresponding to the first elongated groove is positioned on the other of the first longitudinal engagement portion and the third longitudinal engagement portion.

9. The splice enclosure according to claim 8, wherein the second elongated groove is positioned along one of the second longitudinal engagement portion and the fourth longitudinal engagement portion.

10. The splice enclosure according to claim 9, further comprising a second protruding rib corresponding to the second elongated groove is positioned on the other of the second longitudinal engagement portion and the fourth longitudinal engagement portion.

11. The splice enclosure according to claim 5, wherein the first elongated groove is positioned in one of the first longitudinal engagement portion and the third longitudinal engagement portion, while a first planar structure is formed on the other of the first longitudinal engagement portion and the third longitudinal engagement portion.

12. The splice enclosure according to claim 11, wherein the second elongated groove is positioned in one of the second longitudinal engagement portion and the fourth longitudinal engagement portion.

13. The splice enclosure according to claim 12, wherein the a second planar structure is positioned on the other of the second longitudinal engagement portion and the fourth longitudinal engagement portion.

14. The splice enclosure according to claim 2, wherein the broadened portion is positioned along a substantial center of one of the first elongated groove and the second elongated groove.

15. The splice enclosure according to claim 2, wherein the first engagement portion includes two first transverse engagement portions respectively positioned at both ends the cable splice receiving chamber in a transverse direction of the splice enclosure.

16. The splice enclosure according to claim 15, wherein each of the first and second transverse engagement portions includes with the third elongated groove.

17. The splice enclosure according to claim 16, wherein each of the first and second transverse engagement portions is formed into a receiving section, the first and second transverse engagement portions connect to form openings when the first casing and the second casing are closed together.

18. The splice enclosure according to claim 1, wherein the first casing is rotatably connected with the second casing alongside portions in a longitudinal direction of the splice enclosure.

19. The splice enclosure according to claim 10, further comprising a fastening device for holding the first and second casings in a closed position.
